(19) United States
(12) Patent Application Publication
(10) Pub. No.: US 2002/0163971 A1
(43) Pub. Date: Nov. 7, 2002

(54) Video bitstream washer

(76) Inventors: Goran Roth, Malmo (SE); Harald Brusewitz, Alvsjo (SE)

Correspondence Address: Raymond Van Dyke, Jenkens & Gilchrist, P.C., 3200 Fountain Place, 1445 Ross Avenue, Dallas, TX, 75202-2799, US

(21) Appl. No.: 09/791,988

(22) Filed: Feb. 23, 2001

(51) Int. Cl. H04N 7/12

(52) U.S. Cl. 375/240.27; 375/240.12; 375/240.16; 375/240.24; 375/240.2

(57) ABSTRACT

A system, method, and apparatus for correcting a corrupted video bitstream using a video bitstream washer. The video bitstream washer of the present invention receives a corrupted video bitstream and produces a syntactically correct video bitstream as an output using correction and concealment of the errors in the video bitstream. The video bitstream washer may be placed in a network for receiving a corrupt video bitstream from an error-prone network and providing a correct video bitstream to an error-free network, providing a correct video bitstream to a video decoder, or as an integrated bitstream washer and video decoder.

### BACKGROUND OF THE INVENTION

1. Technical Field of the Invention

The present invention relates to the correction and concealment of errors in a video bitstream.

2. Background and Objects of the Present Invention

Due to the advent of mobile radio networks, IP networks, and other such communication networks, a desire has evolved for the transmission of video sequences over these networks. Unfortunately, the transmission of uncompressed video occupies a prohibitively large amount of bandwidth for most networks to be able to handle. For example, High Definition Television (HDTV) video in uncompressed digital form requires about 1 Gbps of bandwidth.

As a result, schemes and standards have been developed for the compression of video sequences so that they may be transmitted over bitstreams that have restricted bandwidths. Video coding schemes have been devised by various groups including the International Telecommunication Union Telecommunication Standardization Sector (ITU-T) producing the H-series of standards, and the Moving Pictures Experts Group (MPEG) producing the MPEG series of standards.

H.261, for example, was developed for videoconferencing and videotelephone applications over ISDN telephone lines around the years of 1988-1990, allowing for the transmission of video over ISDN lines at a data rate of 64-384 kbps at relatively low video quality. MPEG-1 was approved in 1992 with a goal of producing VHS quality video for storage on a CD-ROM, including audio for playback at a rate of about 1.5 Mbps. MPEG-2, approved in 1994, was developed primarily for high quality applications ranging from 4 Mbps to 80 Mbps with quality ranging from consumer tape quality to film production quality. MPEG-2 supports coding at HDTV quality at about 60 Mbps, and forms the basis for many cable TV and satellite video transmissions, as well as storage on Digital Versatile Disc (DVD). H.263 and MPEG-4 have been recently developed with the goal of providing good quality video at very low bit rates, although it may be applied to higher bit rates as well.

A drawback to the use of video compression is that errors in the bitstream may result in greatly degraded picture quality and possibly an undecodable video sequence. This problem becomes even greater when compressed video is transmitted over error-prone networks and transmission paths.

Due to the development of such devices as mobile phones with video display capabilities and devices for network video broadcasting, the transmission of video over error-prone networks, e.g., mobile radio networks and Internet Protocol (IP) networks with packet loss, is desired. However, many end user terminals are not designed or well suited for such networks. Thus, there is a need for devices that can produce decodable bitstreams from erroneous, sometimes not decodable, bitstreams for use by such end user terminals.

### SUMMARY OF THE INVENTION

The present invention is directed to a method, system, and apparatus for correcting a corrupted video bitstream using a video bitstream washer. The video bitstream washer of the present invention receives a corrupted video bitstream and produces a syntactically correct video bitstream as an output by correction and concealment of the errors in the video bitstream. In one embodiment of the present invention, the video bitstream washer may be placed in a network for receiving a corrupt video bitstream from an error-prone network, and providing a syntactically correct video bitstream to an error-free network. In another embodiment of the present invention, the video bitstream washer may receive a corrupt video bitstream from an error-prone network and provide a syntactically correct video bitstream to a video decoder. In still another embodiment, the present invention may be used as an integrated video bitstream washer and video decoder for receiving a corrupt video bitstream from an error-prone network and providing a decoded picture.

### BRIEF DESCRIPTION OF THE DRAWINGS

A more complete understanding of the system, method and apparatus of the present invention may be had by reference to the following Detailed Description when taken in conjunction with the accompanying Drawings wherein:

FIG. 1 illustrates an exemplary embodiment of the video bitstream washer of the present invention;

FIG. 2 illustrates another exemplary embodiment of the video bitstream washer of present invention;

FIG. 3 illustrates a further exemplary embodiment of the video bitstream washer of present invention;

FIG. 4 illustrates an exemplary decoding process of the present invention;

FIGS. 5A and 5B illustrate an exemplary method of Intra DC concealment of the present invention;

FIGS. 6A and 6B illustrate an exemplary method of Intra AC concealment of the present invention; and

FIG. 7 illustrates an exemplary syntactic structure of a video packet pursuant to an MPEG-4 standard.

### DETAILED DESCRIPTION OF THE PRESENTLY PREFERRED EXEMPLARY EMBODIMENTS

The present invention will now be described more fully hereinafter with reference to the accompanying Drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention is directed to a video bitstream washer. As previously described, video transmission is desirable over error prone-networks, for example, mobile radio networks and IP networks with packet loss. Many end user terminals, however, are not designed for such networks. As a result, there is a need for network devices that can produce decodable bitstreams from erroneous bitstreams that could not normally be decoded by user end terminals. For example, many end user terminals do not use error resiliency at all, while some use only simple error resiliency tools. In addition, some Internet Protocol (IP) networks detect and throw away erroneous data so that no error resiliency can be performed. As a result, the end user terminal receiving the transmitted video produces a low quality picture or no picture at all.

The present invention solves this problem by the use of a video bitstream washer, which is placed in the network, such as at a media gateway, and which converts the erroneous, non-compliant bitstream into a correct and decodable bitstream. In contrast to simple error correction, the invention implements error resiliency in the network that would otherwise have to be implemented in the user end terminal. Nevertheless, it should be understood that the invention could also be used in a terminal end. Thus, the video bitstream washer of the present invention allows video transmission over error prone networks, offering a useful and valuable service.

With reference to FIG. 1, there is illustrated an exemplary embodiment of the video bitstream washer of the present invention. In this example, the video bitstream washer 130 is placed between a substantially error prone network 110 and a substantially error-free network 150. A corrupt bitstream 120 is received from the error prone network 110 by the video bitstream washer 130, which outputs a corrected bitstream 140 to the error-free network 150. The corrected bitstream 140 can then be used by an end user terminal for decoding the video bitstream. Examples of error-prone networks which could produce a corrupted bitstream include a wireless network and an IP network. Examples of relatively error-free networks include a local landline network and a cable network.

With reference now to FIG. 2, there is illustrated another exemplary embodiment of the video bitstream washer of the present invention. In this example, the video bitstream washer 230 is placed between an error prone network 210 and a decoder 250. A corrupt bitstream 220 is received from the error prone network 210 by the video bitstream washer 230, which outputs a corrected bitstream 240 to the decoder 250. As a result, the decoder 250 is able to output a decoded picture 260. An example of a system in which this configuration is useful is as a front-end to a television set-top box, generally designated by the reference numeral 270. It should be understood the error-prone network in this embodiment could include, for example, a satellite network or an IP network. As indicated, the video bitstream washer 230 receives the corrupted bitstream and provides a corrected bitstream to the decoder 250 in the set-top box 270. As a result, the set-top box 270 can provide a decoded and error-corrected picture or video sequence to a television set.

FIG. 3 of the Drawings illustrates yet another exemplary embodiment of the video bitstream washer of the present invention. In this example, the video bitstream washer and decoder are integrated into a combined bitstream washer and decoder 330. As shown in FIG. 3, the video bitstream washer and decoder 330 receives a corrupted bitstream 320 from an error-prone network 310 and outputs a decoded picture 340, as with the embodiment shown and described in connection with FIG. 2.

Because video transmission may occupy a large amount of bandwidth, video coding and compression is often desirable. As discussed, video coding schemes have been devised by various groups including the International Telecommunication Union Telecommunication Standardization Sector (ITU-T), producing the H-series of standards, and the Moving Pictures Experts Group (MPEG), producing the MPEG series of standards. For exemplary purposes, the MPEG-4 standard is discussed in detail below. It should be understood however, that the present invention may be applied to any one of a number of video compression schemes, including MPEG-1, MPEG-2, H.261, H.263, and related standards.

In a typical video coding scheme, such as MPEG-4, pixels of a picture are represented by a luminance value (Y) and two chrominance values (Cb, Cr). As is understood in the art, the luminance value (Y) provides a greyscale representation, while the two chrominance values provide color information. Because a luminance-chrominance representation has less correlation than a red-green-blue representation, it is easier to encode the signal more efficiently. A discrete cosine transform (DCT) is used to transform the pixel values in the spatial domain into a coded representation in the spectral or frequency domain. As is understood in the art, a discrete cosine transform (DCT) produces one DC coefficient and a number of AC coefficients. The DC coefficient represents an average of the overall magnitude of the transformed input data and includes a frequency component of zero. However, the AC coefficients may include non-zero sinusoidal frequency components forming the higher frequency content of the pixel data. These DCT coefficients are quantized and subject to variable-length coding (VLC). Because the human eye is more sensitive to low frequencies than high frequencies, the low frequencies are given more importance in the quantization and coding of the picture. Because many high frequency coefficients of the DCT are zero after quantization, VLC is accomplished by runlength coding which orders the coefficients into a one-dimensional array using a zig-zag scan placing low frequency coefficients in front of high frequency coefficients. In this way there may be a number of consecutive zero coefficients leading to more efficient quantization.

The DCT transform is performed on a specified block of pixels in the picture. The DCT coefficients obtained from the DCT transform are often referred to as the “texture information” of the picture. For example, a DCT transform of an 8×8 pixel block results in one DC coefficient and 63 AC coefficients. A separate DCT transform is performed for each of the luminance and two chrominance pixel blocks. Because the luminance component is perceptually more important than the chrominance components, the chrominance DCT transforms are performed at one-fourth of the spatial resolution of the luminance transform to provide lower bandwidth of the compressed video.

A macroblock (MB) used in video coding typically consists of 4 luminance blocks and 2 chrominance blocks. A number of macroblocks form a Video Packet (VP) or a slice. A number of VPs or slices form a frame of a picture. The size and shape of the VPs or slices may vary among various coding schemes and need not necessarily be uniform within the same picture. For example, MPEG-4 allows for the coding of arbitrarily shaped video objects, including an arbitrary number of macroblocks within a picture. A frame of such a video object is referred to as a video object plane (VOP).

Spatial and temporal redundancies which may occur in video objects or frames may be used to reduce the bit rate of transmitted video. Spatial redundancy is only utilized when coding frames independently. This is referred to as intraframe coding, which is used to code the first frame in a video sequence as well as being inserted periodically throughout the video sequence. Additional compression can be achieved by taking advantage of the fact that consecutive frames of video are often almost identical. In what is referred to as “interframe coding”, the difference between two successive frames is coded as the difference between the current frame and a previous frame. Further coding gains can be achieved by taking scene motion into account. Instead of taking the difference between a current macroblock and a previously coded macroblock at the same spatial position, a displaced previously coded macroblock can be used. The displacement is represented by a motion vector (MV). As a result, the current macroblock may be predicted based upon the motion vector and a previous macroblock.

An MPEG-4 data stream contains three major types of video object planes (VOPs). The first type, I-VOPS, consist of self-contained intracoded objects. P-VOPS are predictively coded with respect to previously coded VOPs. A third type, B-VOPs, are bidirectionally coded using differences between both the previous and next coded VOPs. In this third type of VOP, two motion vectors are associated with each B-VOP.

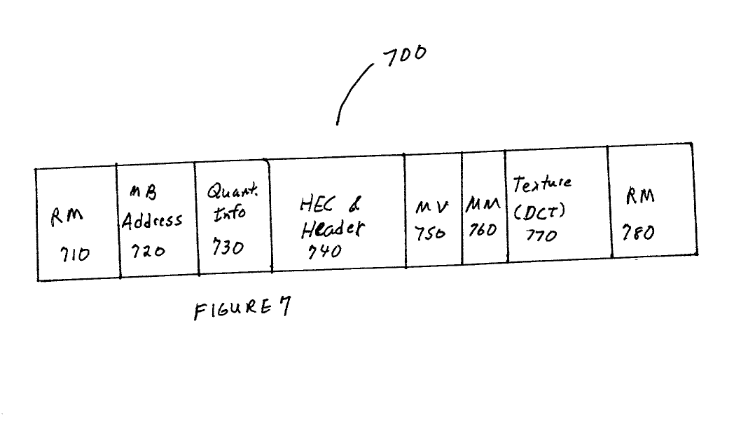

In order to further understand the present invention, it is useful to discuss an example of the syntactic structure of a packet in MPEG-4. As is understood in the art, MPEG-4 packets may be sent in either a data-partitioned mode or a nondata-partitioned mode. An exemplary syntactic structure of an MPEG-4 packet with data partitioning is shown in FIG. 7. As illustrated, a resynchronization marker (RM) 710, which is a unique bit pattern, is placed at the start of a new video packet to facilitate signal detection. In the case of the start of a new picture, a picture sync word (PIC sync), which includes a picture header (PIC header), is used in place of the resynchronization marker 710. Next, a macroblock address (MB) 720, containing the address of the first macroblock in the video packet, is included along with quantization information 730 necessary to decode the first macroblock.

Following the quantization information 730 is the header extension code (HEC) and header 740. The HEC is a single bit indicating whether additional VOP level information will be available in the header. The additional VOP level information may include timing information, temporal reference, VOP prediction type, along with other information. After the HEC and header 740, a Motion Vector field 750 containing the Motion Vector (MV) information, and a Motion Marker field (MM) 760 indicating the end of the Motion Vector information within the packet is included. It should be understood that the Motion Marker 760 acts as a secondary resynchronization marker. Following the Motion Marker 760 is a texture (DCT) information field 770. Finally, a new video packet begins with the next resynchronization marker 780.

It should be understood that in a nondata-partitioning mode, the motion vector information and texture information is not separated by a motion marker. Data-partitioning, which is used for better error resiliency, allows for the use of the motion compensation data and a previously decoded VOP to conceal texture information which may have been lost in the current VOP.

A number additional sub-fields exist within an MPEG-4 packet, three of which are discussed further. A coded block pattern (CBP) exists within the macroblock data to indicate which blocks in the macroblock are coded and which contain zero value coefficients. Also, in intra-coded video frames, a DC Marker exists within the DCT information to separate the DC coefficients from the AC coefficients of the DCT. Finally, a picture type field (pic_type) also exists within the packet to indicate the type of VOP that exists within the packet.

Synchronization

The existence of synchronization codewords within the bitstream is an important contributor to the resiliency of the video packet. These codewords are represented by bit patterns that cannot appear anywhere else in error-free data. The synchronization codewords may consist of either a PIC sync or resynchronization marker (RM). Because MPEG-4 allows RMs at arbitrary macroblock locations, every picture has a PIC sync and an unknown number of RMs. To perform synchronization, the decoder first looks for the next two consecutive synchronization positions (either PIC sync or RM) within the bitstream. The bits between two sync positions is denoted as a packet. The number of bits in a packet is denoted packet_bits. The picture positions (addresses) for the two sync words are decoded and are denoted as mb1 and mb2. The number of macroblocks in a packet is denoted kmb.

Decoding Process

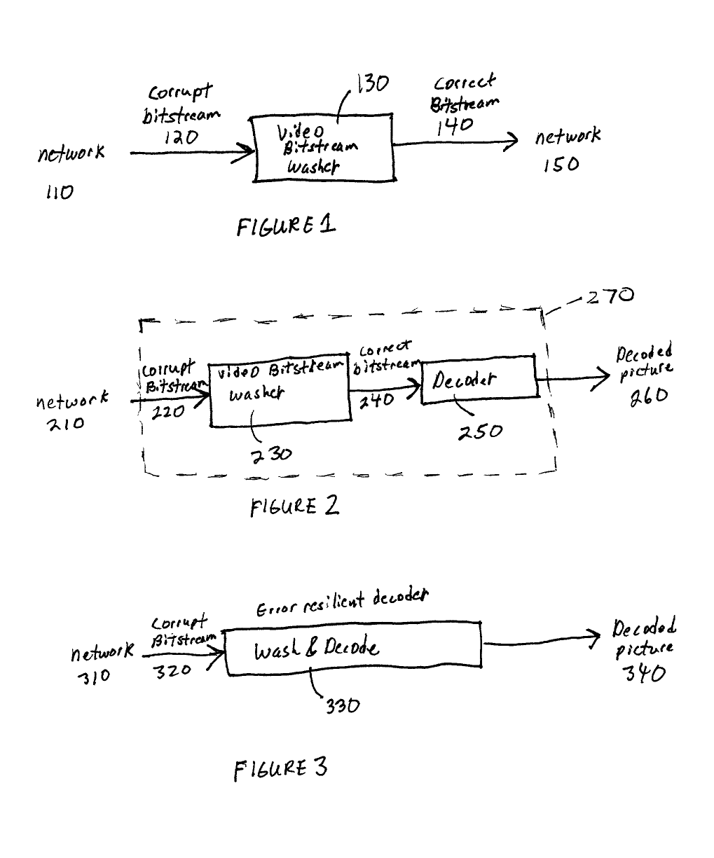

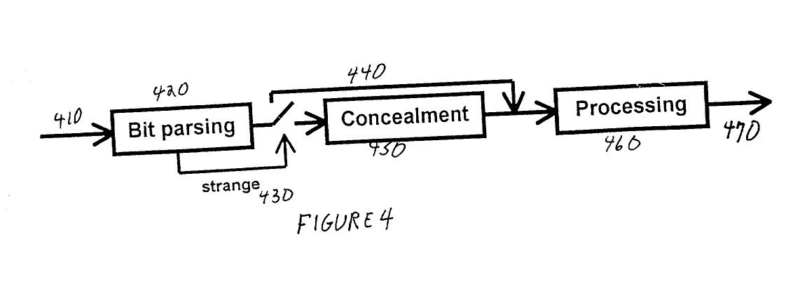

An exemplary decoding process according to the present invention is illustrated in FIG. 4, including the steps of bit parsing 420 of a bitstream 410, concealment 450, and signal processing 460 to produce an output 470. If a “strange event” is detected (generally designated by the reference numeral 430) during bit parsing 420, concealment is performed, i.e., a pathway between the bit parsing 420 and the concealment 450 is made. Otherwise, the concealment step 450 is bypassed (as generally designated by the reference numeral 440). A strange event is defined as the detected occurrence within the bitstream of an error or other data which does not conform to the expected syntactic content of the bitstream.

In an example of the decoding process, a bit parser translates a specific variable length coding (VLC) word (bit pattern) to a DCT component value. A signal processor takes a block of DCT component values and performs an Inverse Discrete Cosine Transform (IDCT) to produce pixel values. If it is thought that the bit parser has output incorrect DCT component values due to transmission error, a concealer 450 may set the DCT components to values which are thought to give the best possible image quality. If, however, no error is found during bit parsing, no concealment is performed and the concealment 450 is bypassed 440, and signal processing 460 will continue. If an error is found indicating a strange event has occurred but which can be corrected, no concealment 450 is performed and signal processing will follow. Finally, if an error is found indicating that a strange event has occurred which cannot be corrected, concealment 450 is performed before signal processing 460.

Some examples of general strange events which may occur in a video bitstream are given in Table 1. Strange event 1 may occur when in the received data the condition 0<mb2<mb1 is met, i.e., possible causes of this strange event include a bit error in mb1 (the mb1 value is too large), a bit error in mb2 (the mb2 is too small) or a corrupted PIC header. Strange events 2 and 3 may occur when an undefined codeword is received or an undefined semantic meaning of a correct codeword exists, i.e., the codeword does not make syntactic sense in the context in which it occurs. A possible cause for these events may include a bit error in the packet. It should be understood that other general strange events which would be known to those skilled in the art may occur.

TABLE 1

| | Strange event | Possible cause |
|---|---|---|
| 1 | 0 < mb2 < mb1 | a) Bit error in mb1 |
| | | b) Bit error in mb2 |
| | | c) Corrupted PIC header |
| 2 | Undefined codeword | a) Bit error in packet |
| 3 | Undefined semantic | a) Bit error in packet |
| | meaning of correct | |
| | codeword | |

Examples of strange events which may occur in a nondata-partitioning mode are given in Table 2. Strange event 4 may occur when the kmb macroblocks have been decoded before packet_bits have been decoded. Possible causes for this event include a bit error in mb2 (the mb2 value is too small) or a bit error in the packet. Strange event 5 may occur when kmb macroblocks have not yet been decoded by the time packet_bits have been decoded. Possible causes for this strange event include a bit error in mb2, a lost second resync marker (RM2), or a bit error in the packet. It should be understood that other strange events which would be known to those skilled in the art may occur in a nondata-partitioning mode.

TABLE 2

| | Strange event | Possible cause |
|---|---|---|
| 4 | kmb MBs decoded | a) Bit error in mb2 |
| | before packet_bits | b) Bit error in packet |
| | have been used | |
| 5 | kmb MBs not yet | a) Bit error in mb2 |
| | decoded when | b) Lost RM2 |
| | packet_bits used | c) Bit error in packet |

Examples of strange events which may occur in data-partitioning mode are given in Table 3. Strange event 6 may occur when a Motion Marker does not exist in a P-VOP packet. Possible causes of this strange event include a bit error in the Motion Marker, an emulated resync marker (RM) before the Motion Marker, or an error in the pic_type. Strange event 7 may occur when a DC Marker (DCM) does not exist within an I-VOP packet. Possible causes of this strange event include a bit error in the DC Marker, an emulated resync marker before the DC Marker, or an error in the pic_type. Strange event 8 may occur when kmb Motion Vectors are decoded before a Motion Marker is decoded. Possible causes of this event include a bit error in the Motion Marker, a bit error in mb2 (the mb2 value is too small), or a bit error in the packet before the Motion Marker. Strange event 9 may occur when kmb Motion Vectors are not decoded by the time the Motion Marker is decoded. Possible causes of this strange event include a bit error in mb2, a lost RM2, a bit error in the packet before the Motion Marker, or an emulated Motion Marker. Strange event 10 may occur when kRb CBPs have not been decoded by the time RM2 is decoded. A possible cause of this strange event may include a bit error in the packet. Strange event 11 may occur when kmb coefficients within the macroblock are not decoded by the time RM2 is decoded. A possible cause of this strange event includes a bit error in the packet. As a final example, strange event 12 may occur when kmb coefficient within the macroblock are decoded before RM2. A possible cause of this strange event may include a bit error in the packet. It should be understood that other strange events which would be known to those skilled in the art may occur in a data-partitioning mode.

TABLE 3

| | Strange event | Possible cause |
|---|---|---|
| 6 | Motion Marker does not | a) Bit error in MM |
| | exist in P-VOP packet | b) Emulated RM before MM |
| | | c) Error in pic_type |
| 7 | DC Marker does not exist in | a) Bit error in DCM |
| | I-VOP packet | b) Emulated RM before |
| | | DCM |
| | | c) Error in pic_type |
| 8 | kmb MVs decoded before MM | a) Bit error in MM |
| | | b) Bit error in mb2 |
| | | c) Bit error in packet |
| | | before MM |
| 9 | kmb MVs not decoded before | a) Bit error in mb2 |
| | MM | b) Lost RM2 |
| | | c) Bit error in packet |
| | | d) MM emulated |
| 10 | kmb CBPs not decoded at RM2 | a) Bit error in packet |
| 11 | kmb COF MBs not decoded at | a) Bit error in packet |
| | RM2 | |
| 12 | kmb COF MBs decoded before | a) kmb COF MBs decoded |
| | RM2 | before RM2 |

It should be understood that upon the detection of many strange events, it is possible to locate and correct the underlying error. Methods for correction of these errors are well known to those skilled in the art. In cases when an strange event error cannot be corrected, some transmitted data will have to be ignored and concealment will be used. Several examples are presented of strange event errors which cannot be corrected along with appropriate actions which can be taken. For example, for an uncorrectable strange event in a nondata-partitioning packet, all data in the packet may be ignored. For an uncorrectable strange event error before the DC Marker in an I-VOP or before the Motion Marker in a P-VOP, all data in the packet may be ignored. For an uncorrectable strange event after a DC Marker in an I-VOP, CBP and AC components may be ignored. For an uncorrectable strange event after a Motion Marker in a P-VOP, CBP and DCT components may be ignored while Motion Vectors may be used. As a final example, for the case when an Intra DC in an I-VOP is out of range, the Intra DC may be ignored. It should be understood that other methods of concealment which would be known to those skilled in the art may be used.

Concealment

Three examples of concealment methods are discussed. In the first concealment method, all DCT components in a P-VOP are set to zero. In the second concealment method, a Motion Vector from a correctly decoded Motion Vector in a neighboring macroblock is copied. If no such correctly decoded Motion Vector exists, the Motion Vector is set to zero. In a third concealment method, I-VOP DCT components are derived from surrounding correctly decoded macroblocks. If no such macroblocks exist, already concealed data are used.

During Motion Vector concealment, the four surrounding Motion Vectors are checked. If at least one of them is transmitted without an error being detected, it is used in the concealed macroblock. If no correctly decoded Motion Vector is found, the concealed Motion Vector is set to zero. If the current macroblock is not correctly decoded, other macroblocks in the same packet may also not be correctly decoded. In this case, it is most likely that the macroblock above or below contains a Motion Vector which can be used for concealment.

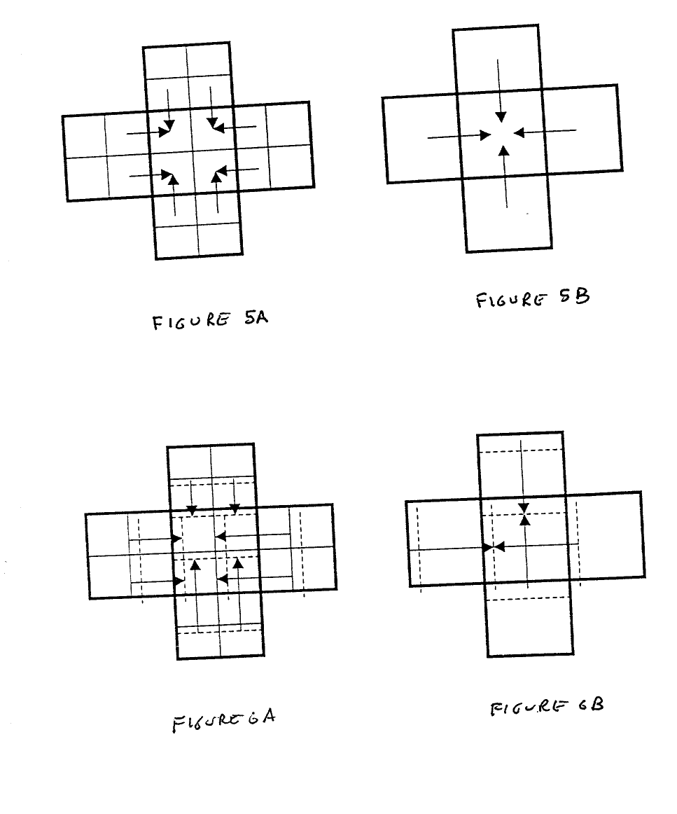

During Intra DC concealment, the four surrounding macroblocks are used. Those macroblocks which have been correctly decoded are denoted as “useful” and are used for concealment of the current macroblock. All useful DC components are interpolated in the concealment procedure. With reference now to FIGS. 5A and 5B, there are illustrated the various DC components which are involved. As shown, the luminance DC components in FIG. 5A are interpolated from at most two surrounding values, while the chrominance components in FIG. 5B are interpolated from four surrounding values. Accordingly, if a particular luminance DC value cannot be concealed because its two corresponding neighboring values are not correctly decoded, it is instead concealed from the two neighboring DC values inside the macroblock which are already concealed. In the case that all four surrounding macroblocks are not decoded correctly, concealment of the current macroblock is done with concealed values in neighboring macroblocks.

With reference now to FIGS. 6A and 6B, there are illustrated the various Intra AC components, which are concealed in a similar way as DC values, from surrounding correctly decoded macroblocks. Only pure horizontal, and pure vertical AC components are concealed. As illustrated in FIG. 6A, for luminance, the values are copied from one neighboring macroblock. For chrominance, however, the values are interpolated from two surrounding macroblocks, as illustrated in FIG. 6B. Horizontal AC components are copied or interpolated from above and below. Vertical AC components are copied or interpolated from left and right. If a neighboring macroblock is not useful, the corresponding concealment is not performed.

It should be understood that other methods of concealment which would be known to those skilled in the art may be used in the present invention.

Although various embodiments of the method, system, and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the scope of the invention as set forth and defined by the following claims.

What is claimed is:

1. An apparatus for correcting a video bitstream which has been corrupted by errors, said apparatus comprising:
a receiver for receiving a corrupt video bitstream, said corrupt video bitstream having at least one error therein; and
a video bitstream washer in communication with said receiver for producing a syntactically correct video bitstream from said corrupt video stream.

2. The apparatus of claim 1, wherein said corrupt video bitstream is received from a substantially error-prone network.

3. The apparatus of claim 2, wherein said substantially error-prone network comprises a mobile radio network.

4. The apparatus of claim 2, wherein said substantially error-prone network comprises a satellite network.

5. The apparatus of claim 2, wherein said substantially error-prone network comprises an IP network.

6. The apparatus of claim 1, wherein said syntactically correct bitstream is received by a substantially error-free network.

7. The apparatus of claim 6, wherein said substantially error-free network comprises a landline network.

8. The apparatus of claim 1, said apparatus further comprising:
a video decoder in communication with said video bitstream washer for receiving said syntactically correct video bitstream and producing a decoded video image signal therefrom.

9. The apparatus of claim 8, wherein said video decoder comprises an end user terminal.

10. The apparatus of claim 9, wherein said end user terminal comprises a mobile telephone.

11. The apparatus of claim 9, wherein said end user terminal comprises a television set-top box.

12. The apparatus of claim 1, wherein said syntactically correct video bitstream comprises a compressed video bitstream.

13. The apparatus of claim 12, wherein said compressed video bitstream comprises an MPEG-based video bitstream.

14. The apparatus of claim 12, wherein said compressed video bitstream is selected from the group consisting of an MPEG-1 bitstream, an MPEG-2 bitstream, and MPEG-4 bitstream, an H.261 bitstream, an H.263 bitstream, and combinations thereof.

15. An error resilient video decoder for correcting a video bitstream which has been corrupted by errors, said error resilient video decoder comprising:
a receiver for receiving a corrupt video bitstream, said corrupt video bitstream having at least one error therein;
a video bitstream washer in communication with said receiver for producing a syntactically correct video bitstream from said corrupt video stream; and
a video decoder in communication with said video bitstream washer for receiving said syntactically correct video bitstream and producing a decoded video image signal therefrom.

16. The error resilient video decoder of claim 15, wherein said corrupt video bitstream is received from a substantially error-prone network.

17. The error resilient video decoder of claim 15, wherein said error resilient video decoder comprises an end user terminal.

18. The error resilient video decoder of claim 17, wherein said end user terminal comprises a mobile telephone.

19. The error resilient video decoder of claim 17, wherein said end user terminal comprises a television set-top box.

20. The error resilient video decoder of claim 15, wherein said syntactically correct video bitstream comprises a compressed video bitstream.

21. A method for modifying a video bitstream which has been corrupted by errors, said method comprising the steps of:
receiving a corrupt video bitstream, said corrupt video bitstream having at least one error therein;
if said at least one error is correctable, correcting said at least one error in said corrupt video bitstream; and
if said at least one error is not correctable, concealing said at least one error in said corrupt video bitstream,
whereby a syntactically correct video bitstream is produced from said corrupt video bitstream.

22. The method of claim 21, wherein said receiving step further comprises the steps of:
detecting consecutive synchronization markers in said corrupt video bitstream to determine a video packet;
determining the picture addresses of each of said consecutive synchronization markers; and
calculating the number of macroblocks within said packet.

23. The method of claim 21, wherein said receiving step further comprises the step of:
parsing the bits of said corrupt video bitstream to detect said at least one error.

24. The method of claim 21, wherein said concealing step further comprises the steps of:
detecting an error in motion vector data in a macroblock of said corrupt video bitstream; and
replacing said motion vector data using neighboring error-free macroblock motion vector data.

25. The method of claim 21, wherein said concealing step further comprises the steps of:
detecting an error in Discrete Cosine Transform (DCT) coefficients in a macroblock of said corrupt video bitstream; and
replacing said Discrete Cosine Transform coefficients with data from interpolated neighboring Discrete Cosine Transform coefficients.

26. The method of claim 21, said method further comprising the step of:
providing said syntactically correct video bitstream to a substantially error-free network.

27. The method of claim 21, said method further comprising the steps of:
decoding said syntactically correct video bitstream to produce a decoded video bitstream; and
producing at least one video image signal from said decoded video bitstream.

28. A system for washing the bits of a video bitstream between a first network and a second network, said first network being substantially error-prone, said second network being substantially error-free, said system comprising:
an input for receiving a corrupt video bitstream from said first network, said corrupt video bitstream having at least one error therein;
a video bitstream washer in communication with said input for producing a syntactically correct video bitstream from said corrupt video bitstream; and
an output in communication with said video bitstream washer for providing said syntactically correct video bitstream to said second network.

29. The system of claim 28, wherein said first network comprises a wireless network.

30. The system of claim 29, wherein said wireless network comprises a mobile telephone network.

31. The system of claim 28, wherein said first network comprises an IP network.

32. The system of claim 28, wherein said second network comprises a wireline network.
